(19) United States
(12) Patent Application Publication
(10) Pub. No.: US 2007/0050710 A1
(43) Pub. Date: Mar. 1, 2007

(54) Graphical user interface for a web application

(76) Inventor: Christopher K. Redekop, Calgary (CA)

Correspondence Address: FISH & RICHARDSON P.C., PO BOX 1022, MINNEAPOLIS, MN, 55440-1022, US

(21) Appl. No.: 11/235,793

(22) Filed: Sep. 26, 2005

Related U.S. Application Data
(60) Provisional application No. 60/713,396, filed on Aug. 31, 2005.

(51) Int. Cl. G06F 15/00

(52) U.S. Cl. 715/523

(57) ABSTRACT

Systems and techniques to provide a graphical user interface. In general, in one implementation, the technique includes receiving in a web browser executing on a client a representation of the graphical user interface for the web application from a server, where the representation includes a description of at least one boundary element, the at least one boundary element including within a boundary established by the boundary element at least one of text, a graphic or a control element; receiving in the web browser services, the services specified in a scripting language; executing at least one of the services at the client to detect a web browser document object model and rendering the at least one boundary element displayed within a boundary of the web browser window.

### CROSS REFERENCE TO RELATED APPLICATION

This application claims priority to pending U.S. Provisional Application Ser. No. 60/713,396, entitled “Graphical User Interface for a Web Application”, filed on Aug. 31, 2005, the entire contents of which are hereby incorporated by reference.

### TECHNICAL FIELD

This document relates to graphical user interfaces in web-based applications.

### BACKGROUND

Web-based applications can use a number of techniques for providing a graphical user interface (GUI). One approach is to use animation tools that require proprietary plug-ins to be preinstalled. These solutions have limited flexibility and portability between web browsers. Another approach to creating a GUI for a web-based application is to display a pop-up window containing GUI elements as illustrated in FIG. 1. In this example, a web browser window 100 displays a web-based application GUI. Selection of a button 104 by a user causes a pop-up window 102 to appear. The pop-up window 102 is a separate browser window from the browser window 100 displaying the GUI, and is not constrained to stay within the bounds of the browser window 100. In this example, a portion 106 of the pop-up window 102 does not overlap browser window 100. Note also that there is no way for a software developer to control the precedence between the windows in this example. This can be confusing to a user since the pop-up window 102 does not appear to be logically connected to the browser window 100. In addition, many web browsers disable pop-up windows for security reasons. Yet another approach to creating a GUI is by writing client-side HTML and JavaScript code that causes the web browser to create the elements of the GUI. However, since different web browsers can include non-standard extensions to web standards and may have different document object models, the JavaScript code may be browser specific, and not portable from one web browser to the next.

### SUMMARY

Systems and techniques relating to providing a user interface for a web-based application are described.

In one aspect, a GUI for a web application is provided by receiving in a web browser executing on a client a representation of the graphical user interface for the web application from a server, where the representation includes a description of at least one boundary element, the at least one boundary element including within a boundary established by the boundary element at least one of text, a graphic or a control element. The web browser receives services, the services specified in a scripting language. The client executes at least one of the services at to detect a web browser document object model from among a plurality of possible web browser document object models, where the detected web browser document object model corresponds to the web browser executing on the client. The client selectively executes a portion of the services to modify the detected document object model to include information pertaining to the at least one boundary element, where the portion is selected based on which document object model was detected. The GUI is rendered in a web browser window, including, based on the modified document object model, rendering the at least one boundary element displayed within a boundary of the web browser window.

In another aspect, a GUI for a web application is provided by receiving in a web browser executing on a client a representation of the graphical user interface for the web application from a server, where the representation includes a description of at least one boundary element, the at least one boundary element including within a boundary established by the boundary element at least one of text, a graphic or a control element. The web browser receives the services, the services specified in a scripting language. The client executes at least one of the services to detect a web browser document object model from among a plurality of possible web browser document object models, where the detected web browser document object model corresponds to the web browser executing on the client. The client selectively executes a portion of the services to modify the detected document object model to include information pertaining to the at least one boundary element, where the portion is selected based on which document object model was detected. The GUI is rendered in a web browser window, including, based on the modified document object model, rendering the at least one boundary element displayed within a boundary of the web browser window, the graphical user interface providing one or more fields for user input. User input is received within the one or more fields, the user input comprising at least one of time keeping information or resource management information.

In another aspect, a modal dialog for a web application is provided by receiving in a web browser executing on a client a representation of a graphical user interface for the web application from a server, where the representation includes a description of a modal dialog boundary element, the modal dialog boundary element including within a boundary established by the modal dialog boundary element at least one control element. The web browser receives services, the services specified by a scripting language. The client executes at least one of the services to detect a web browser document object model from among a plurality of possible web browser document object models, where the detected web browser document object model corresponds to the web browser executing on the client. The client selectively executes a portion of the services at the client to modify the detected document object model to include information pertaining to the modal dialog boundary element. The GUI is rendered in a web browser window, including, based on the modified document object model, rendering the modal dialog boundary element within the boundary of the web browser window.

Implementations may include one or more of the following features. The representation can include functionality for performing detection and modification of a document object model. The representation and the services can be received in a same HTML document. The representation can include JavaScript for performing the detecting and the modifying. Services can be interpreted and boundary elements can be instantiated in a detected document object model. A representation of the GUI can be requested from a server. Time keeping information can include an amount of time spent on a project, a billable rate based on one project, task or employee role, and a time off request. Resource management information can include a time schedule. A user can be prevented from avoiding a modal dialog by disabling elements in the GUI other than the modal dialog and/or by creating a transparent, translucent or opaque layer beneath the modal dialog.

These general and specific aspects may be implemented using a system, a method, or a computer program, or any combination of systems, methods, and computer programs. Details of one or more implementations are set forth in the accompanying drawings and the description below.

Certain implementations may have one or more of the following advantages. One advantage is that boundary elements created according to the teachings in this disclosure are portable across a variety of web browsers. As a result, boundary elements can provide developers with greatly simplified implementations and a consistent user experience across multiple web browsers. Another advantage is that a web browser does not require a pre-installed plug-in in order for boundary elements to display and function. Also, the client-side implementation allows developers to address problems that could not be addressed from the server-side. For example, window positioning, sizing, scrolling attributes and maximizing/minimizing windows require client-side control. Yet another advantage comes from the ability to provide a modal dialog for a web page that is operable across a variety of web browsers. Other features and advantages may be apparent from the description and drawings, and from the claims.

### DRAWING DESCRIPTIONS

FIG. 1 is an illustration of a pop-up window in a web application.

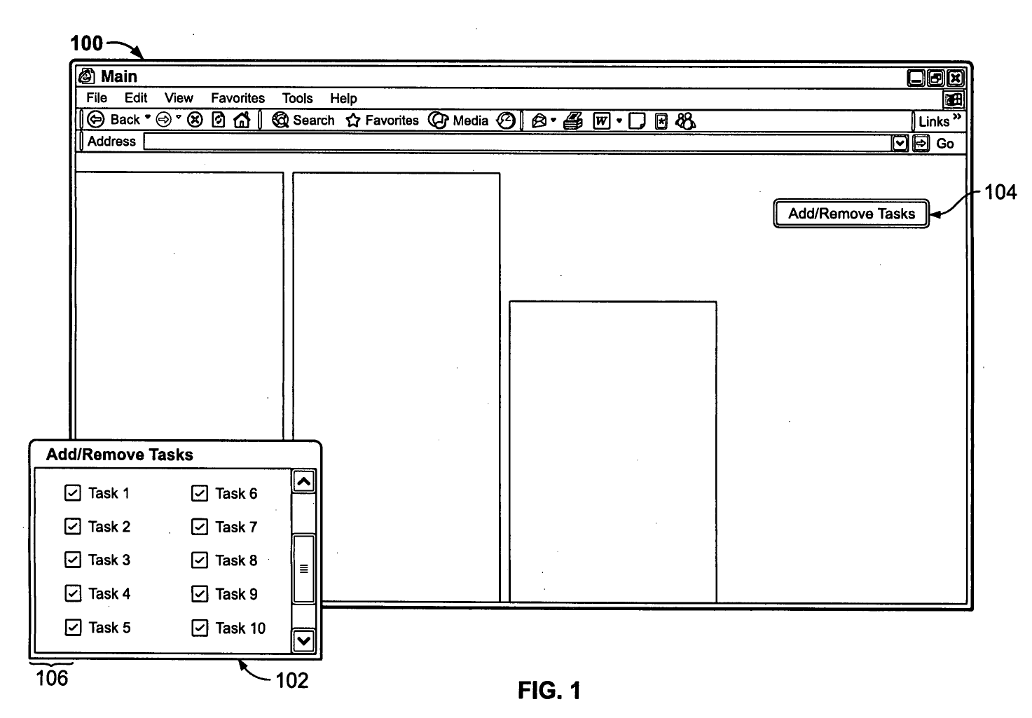

FIG. 2 is an illustration of a boundary element in a graphical user interface.

FIG. 3 is a schematic representation of a system for providing boundary elements in a graphical user interface.

FIG. 4 is an illustration of layered boundary elements in a graphical user interface.

FIG. 5 is an illustration of a windowed graphical user interface using boundary elements.

FIG. 6 is an illustration of a modal dialog user interface element in a graphical user interface.

FIG. 7 is a flow diagram showing a process for rendering a graphical user interface including boundary elements.

FIG. 8 is a flow diagram showing a particular implementation of a process for rendering a graphical user interface including boundary elements.

### DETAILED DESCRIPTION

This disclosure relates to systems and techniques for providing a GUI for a web application. A web application, generally, is a software application executing on a web or application server and communicating with a web browser executing on a client computer. The client computer can be any computing device, including, a PC, cellular telephone, PDA (personal digital assistant), laptop, or other device. An exemplary web application is Web Resource available from Replicon Inc. of Calgary, Alberta, Canada. Web Resource is a resource management web application that provides users the ability to create and share time schedules via a web page interface. Another exemplary web application is Web TimeSheet (also available from Replicon Inc.). Web TimeSheet allows employees or other timekeepers to enter time information (e.g., hours worked) on a web page for given activities and track time on given projects and tasks. Other functionality is possible, and the Web Resource and Web TimeSheet products are merely two examples of web applications. For illustrative purposes, the systems and techniques described below are described in the context of the Web Resource and Web TimeSheet products, although, it should be understood that other web applications can use the systems and techniques described.

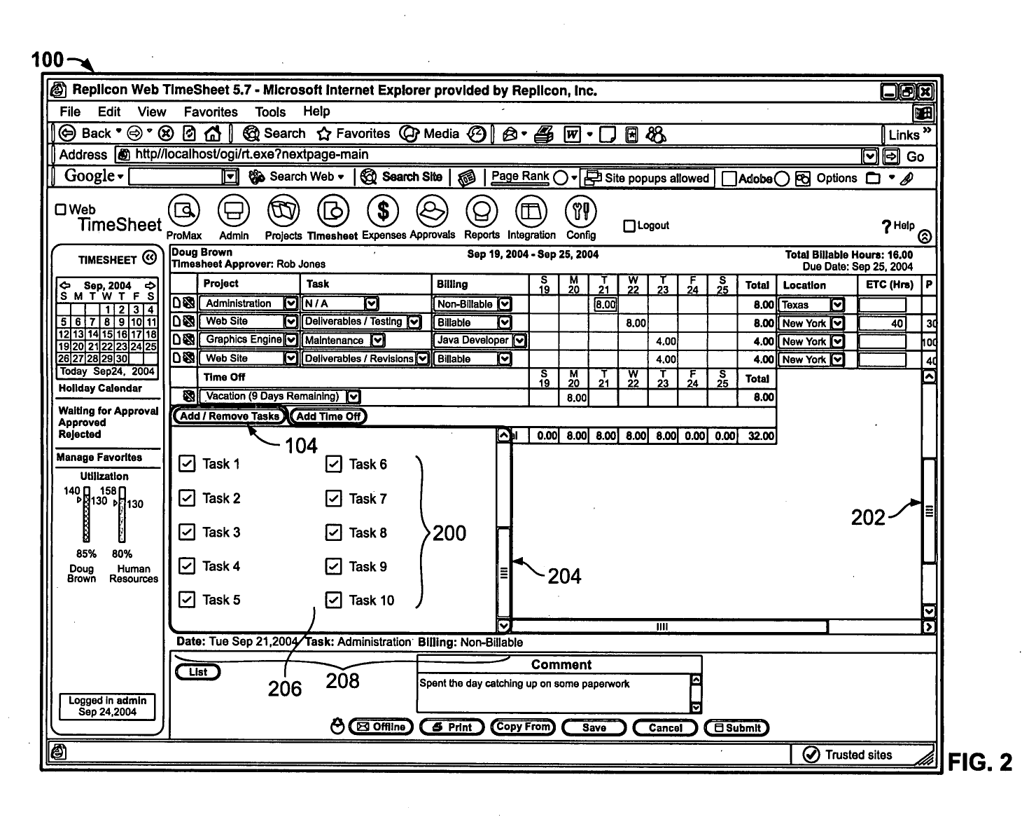

To display a GUI for a web application, a client receives a representation of the GUI for the web application from a server. The representation includes a description of a “boundary element”. Referring to FIG. 2, an exemplary boundary element 206 is shown. A boundary element is an element having a visual appearance of a “window within a window”; however, the boundary element is displayed within the same browser window as the balance of the GUI. For example, a single browser window 100 is shown. The boundary element 206 is displayed within the boundaries of the browser window 100 and is not a separate browser window (i.e., is not a pop-up window). In this example, the boundary element 206 was displayed in response to a user selecting button 104, a control element.

A boundary element can include various sub-elements, for example, text, graphics and/or control elements. The boundary element 206 shown includes multiple check-box control elements 200. Other examples of control elements that can be displayed within a boundary element include the following, which list is illustrative and not exhaustive: a button, a text field, a slider bar, a menu item, a pull-down menu, a check box, a dialog box, a scrollbar, a table, radio buttons, a list box and combinations thereof.

Once the representation of the GUI is received at the client, a web browser document object model is detected at the client from among a plurality of possible web browser document object models. The detected web browser document object model corresponds to a web browser executing on the client. The detected document object model is modified at the client to include information pertaining to the boundary element, e.g., boundary element 206. The GUI is then rendered in a web browser window, including, based on the modified document object model, rendering the boundary element displayed within the boundary of the web browser window. A GUI provided according to this method does not require a web browser plug-in, is portable across web browsers, and does not fall prey to web browser pop-up window blocking. Further, boundary elements allow for much easier implementation since programmers are not required to account for different browsers and browser versions.

In one implementation, a boundary element can be represented as an HTML <div> element. The <div> element creates a logical division or section on a web page (and a corresponding representation in the document object model) that allows elements to be placed and aligned within the division. All elements within the boundary element can be rendered with standard HTML. In an aspect of this implementation, the <div> element can include a nested <table> element to control sizing and scrolling behavior.

Referring again to FIG. 2, an exemplary GUI including various elements, including boundary elements and control elements included within boundary elements, is shown. For illustrative purposes, a GUI from the Web TimeSheet web application mentioned above is shown. However, as described previously, Web TimeSheet is merely one example of a web application that can implement the features described herein. In the example shown, when a button control element 104 is selected by a user, e.g., by clicking a mouse, a boundary element 206 including interactive functionality is activated and displayed. A boundary element can float freely or, as illustrated here, can be “attached” to one or more other elements within the GUI. For example, button control element 104 is a component of the GUI displayed within the web browser window 100, and the boundary element 206 is attached to the button control element 104. The boundary elements, and control elements and/or text displayed within the boundary elements, are displayed within the same window 100 as the other elements within the GUI.

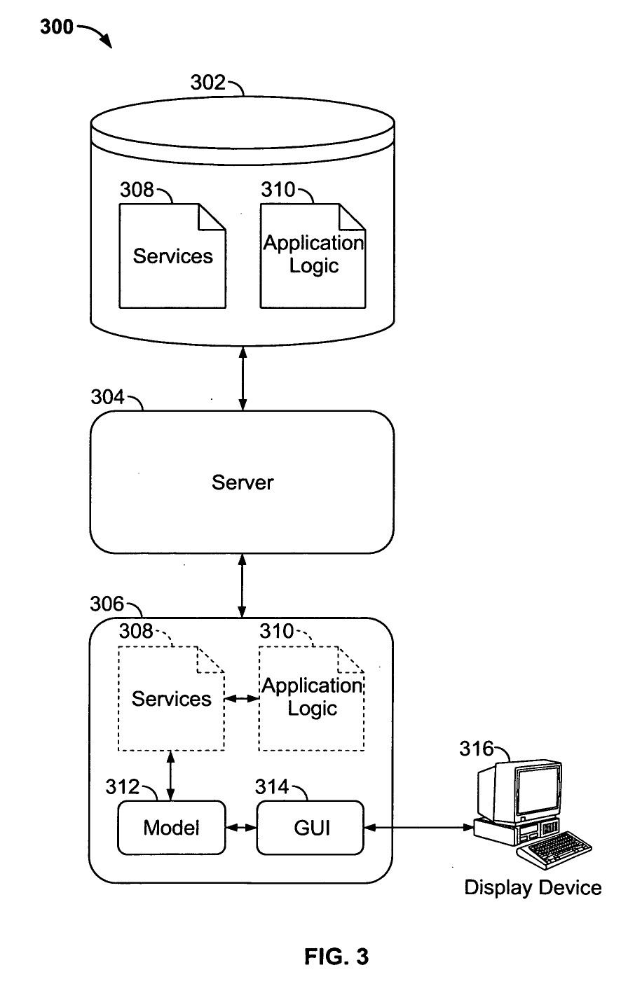

Referring to FIG. 3, a system 300 is illustrated for providing boundary elements. The system 300 includes a server 304, a client 306 and a display device 316. The server 304 is capable of accepting requests from the client 306 and delivering information from storage 302 to the client 306. The client 306 is capable of accepting information from the server 304 and providing a GUI for an end user. In one embodiment, the server 304 and the client 306 participate in a web application, e.g., Web Resource as described above. In one implementation, the server 304 is a web/application server (or proxy for such) and the client 306 is capable of rendering DHTML and interpreting JavaScript (or is a proxy for such).

When a client-side user accesses a web application from the server 304, for example, by inputting a URL into a web browser, the client 306 receives client-side application logic 310 from the server 304. Additionally, the client 306 receives a representation of a GUI 314 for display, e.g., on a display device 316 coupled to the client 306. The representation of a GUI, which in one implementation is a web page, includes a group of services 308. The services 308 implement functionality for creating, configuring and manipulating boundary elements included within the GUI. The services 308 allow the client-side application logic 310 to interact with a model 312.

The model 312 can be a document object model (DOM) corresponding to the web browser executing on the client 306, and includes a representation of boundary and control elements, some or all of which can be visually presented to a user on a display device 316. Modifications to the model 312 by the services 308 can be reflected in the GUI 314, which is a rendering of the model 312 on the display device 316. The client-side application logic 310 uses the services 308 to modify the model 312 resulting in the display of the boundary elements within the GUI 314 on the display device 316. In one embodiment, the client-side application logic 310 is provided to the client 306 by the server 304, e.g., the client-side application logic 310 and services 308 can be included in a web page provided to client 306 by server 304 or another suitable process. In another embodiment, the client-side application logic 310 and services 308 can be obtained from a file or a process other than the server 304.

Different clients 306 can have different, incompatible models 312, particularly if executing different web browsers. However, the services 308 are portable across different types of models 312. That is, the services 308 are configured so as to modify models corresponding to various web browsers, e.g., Internet Explorer, Mozilla Firefox, and Apple Safari, and can essentially hide any differences in the models from the perspective of the client-side application logic 310, from the perspective of the developer building the application and from the perspective of any other upstream component. Accommodation for different models is incorporated into the services 308 themselves, such that each client receives the same group of services and the services 308 include functionality for interacting with various possible models 312 corresponding to various web browsers.

Referring again to FIG. 2, boundary elements can be positioned relative to existing control elements or other elements in window 100, relative to the window 100, relative to frames within the window 100, relative to a cursor, and/or positioned in an absolute location within the window 100 or a frame. If a boundary element's normal position would be partially obscured by the edge of the window 100 or some other element, the boundary element's position can be automatically corrected so that the boundary element is fully visible. Boundary elements can also be sized to accommodate their content, sized relative to existing elements on the page, or sized using absolute dimensions. By way of example, the boundary element 206 has a width 208 which is configured to automatically accommodate the maximum width of the control elements 200 included within the boundary element 206, and includes a scroll bar 204 to “extend” the boundary element 206 vertically.

When the window 100 is scrolled by a user (e.g., via a scrollbar 202 or other suitable mechanism), or when a frame within the window 100 is scrolled by a user, several behaviors are possible for a boundary element. A boundary element can remain in the boundary element's original position despite scrolling in the parent window/frame beneath it, a boundary element can scroll with the parent window/frame maintaining the boundary element's absolute or relative position, and/or a boundary element can scroll with the parent window/frame to the extent that the boundary element remains visible. Boundary elements can themselves have scrollable contents. In this illustration, the boundary element 206 has a scroll bar 204 to allow a user to scroll through the boundary element's contents, which include the control elements 200, which may not be visible all at once.

In one implementation, a boundary element can be “dragged” from an initial position to a new position within the window 100. This allows a user to position a boundary element in a more preferable location. By way of illustration, dragging can be accomplished in one embodiment when a user positions a mouse cursor over a portion of the boundary element 206 and then moves the mouse cursor to a new location while depressing a mouse button or keyboard key. Other techniques to reposition the boundary element 206 can be used.

The appearance and disappearance of boundary elements can use transition effects such as fading in/out and/or animation. In one embodiment, transitions can be provided through a Dynamic Hypertext Markup Language (DHTML) extension. In a further embodiment, custom transitions can be specified through a component such as an ActiveX® control or other software component (ActiveX is a registered trademark of Microsoft Corp.)

Boundary elements can also act as containers for control elements, for example, the checkbox control elements 200 are contained in the boundary element 206. Complex boundary elements can be constructed from combinations of other control elements. For example, boundary element 206 can be instantiated as a single, complex “add/remove tasks” boundary element. This allows groups of control elements to be treated singularly for many operations (e.g., creation, deletion, positioning, displaying, hiding, and event registration).

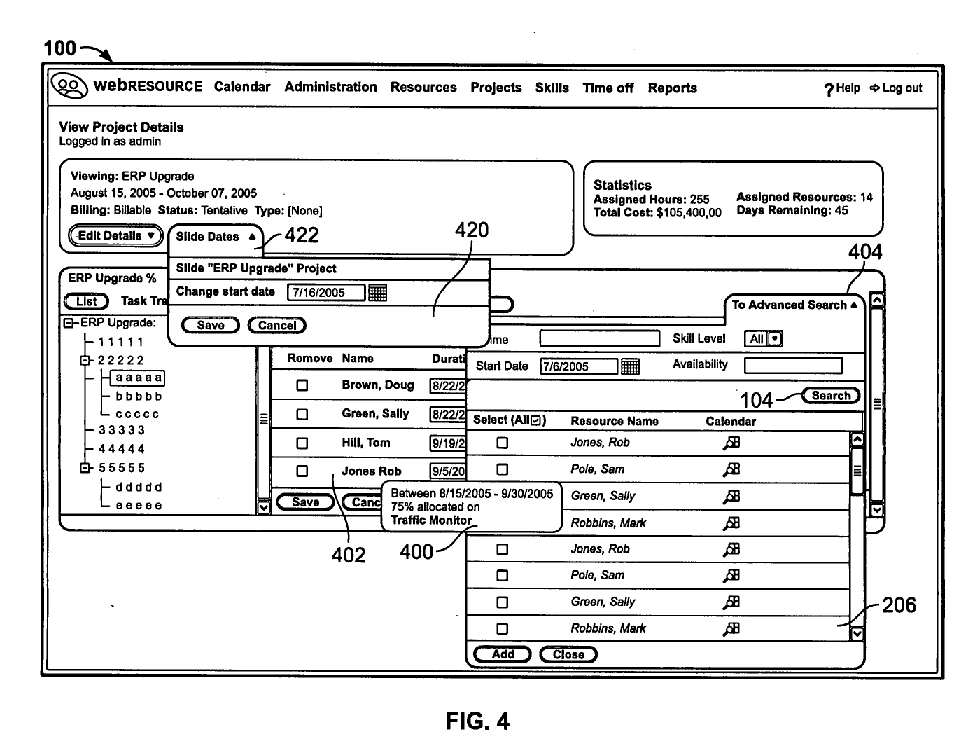

Referring to FIG. 4, boundary elements can be placed in layers such that they appear to “float” over other elements that reside in lower layers. Unlike the behavior of pop-up windows, which are not attached to other GUI elements and are not constrained to remain within the bounds of a parent window, boundary elements appear visually integrated since they can be attached to one another and are constrained to remain within the bounds of a parent window or frame. In this figure, the window 100 includes the “To Advanced Search” tab 404 having the boundary element 206 positioned adjacent to it. The boundary element 206 is partially obscured by a tool tip boundary element 400, which is in a layer above the boundary element 206 and also partially obscures a control element 402. Likewise, a boundary element 420 is attached to a control element 422 and partially obscures the boundary elements 402 and 206. In one embodiment, the system uses Z-order management to automatically manage which boundary elements should appear on top of others. In one implementation, the boundary element last used appears in the uppermost layer and a user can select a boundary element in order to bring that boundary element to a foreground layer and give the selected boundary element input focus.

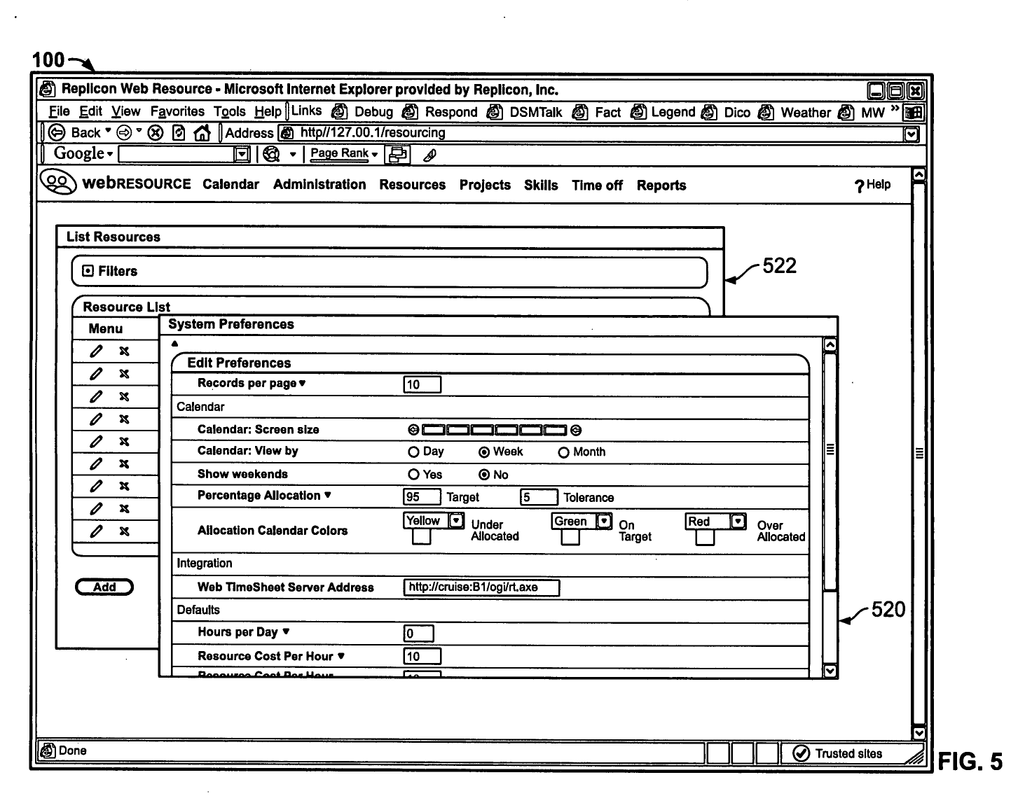

Referring to FIG. 5, in one implementation, the boundary elements 520, 522 are configured to appear as “floating windows”. In fact, the boundary elements 520 and 522 are boundary elements displayed within a single browser window 100. However, a boundary element, e.g., the boundary element 522, can be unattached to any other elements and is thus appear “free floating”, although within the confines of the window 100. This can allow for the cascading effect of multiple “windows” (i.e., boundary elements), providing ease of use and familiarity to a user. In the example shown, the boundary element 522 is partially obscured by another boundary element 520 in a layer above. By way of illustration, if a user were to select the boundary element 522, in one implementation the boundary element 522 is displayed in the foreground, appearing on top of the boundary element 520. In one implementation, both boundary elements can be resized, minimized, and moved within the bounds of the window 100 by a user.

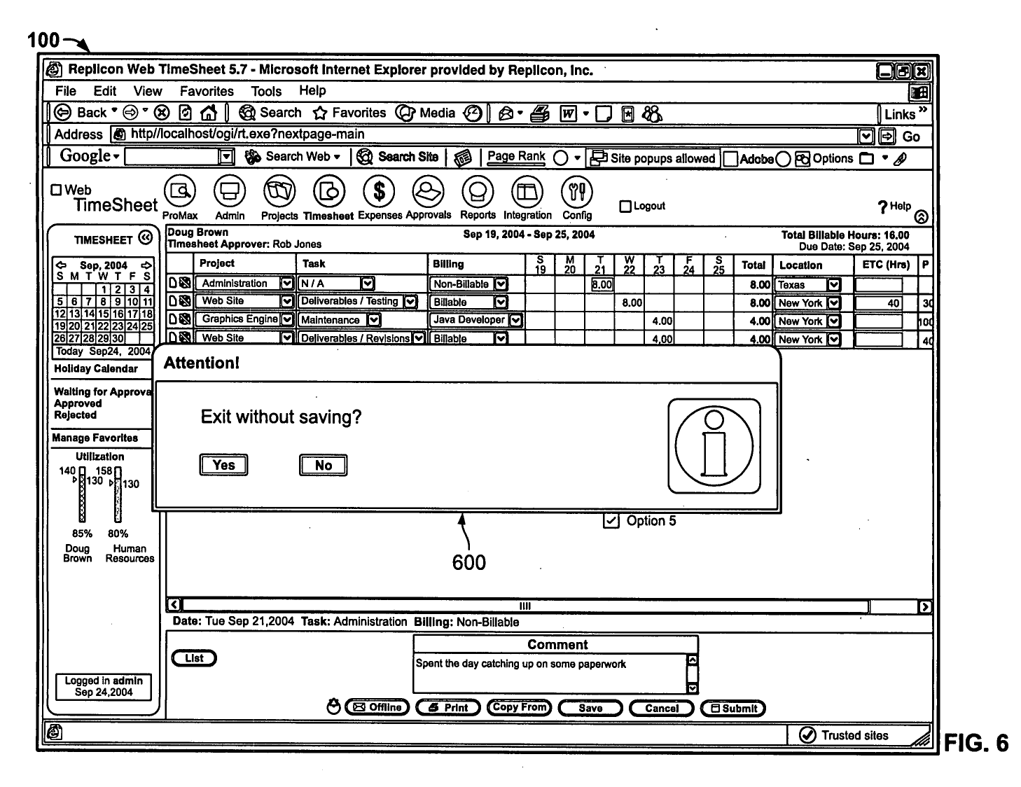

Referring to FIG. 6, a modal dialog boundary element 600 is illustrated superimposed on the GUI displayed in the window 100. The modal dialog 600 provides a way to require a user to interact with a dialog box, by preventing the user from interacting with any other element in the window 100 until completing an interaction with the modal dialog 600. The modal dialog 600 is not displayed in a separate browser window; both the modal dialog 400 and the other elements of the GUI are all displayed within one browser window, i.e., window 100. In one embodiment, this feature can be implemented by making a “blocking” window (e.g., a transparent, translucent or opaque layer that covers the entire viewable window 100) and displaying the modal dialog boundary element 600 on a layer above the blocking window. The user is still able to see the graphical elements displayed on the GUI beneath the blocking window (i.e., if the window is not opaque), but the graphical elements, including the control elements therein, appear disabled to the user. Once the modal dialog 600 is dismissed (i.e., has accepted user input), the blocking window disappears, and all control elements are “enabled” from the user's perspective.

In another embodiment, the modal dialog feature can be implemented by iterating through the boundary and control element representations in the executing web browser's DOM and causing the elements to become disabled and/or hidden. In addition, some control elements may require that their events be blocked. Once the modal dialog 600 is dismissed (i.e., has accepted user input), all boundary/control elements are returned to their former state.

Referring again to FIG. 3, in one implementation, boundary elements can register event handlers to receive events such as, but not limited to, events created by mouse/keyboard activity (e.g., click, double-click, hovering, change of input focus, resizing of boundary elements, moving of boundary elements), timer-based events, and other events generated by the client 306. In one embodiment, the boundary elements have default event handlers for common event types. Programmers can customize these event handlers by supplanting the default handler code or add new event handlers not provided by default. In one embodiment, events flow from the display device 316 to the model 312. Each time an event fires, one or more event handlers (not shown) can be invoked. In a further embodiment, any event that can be used to activate JavaScript can be used to activate boundary elements.

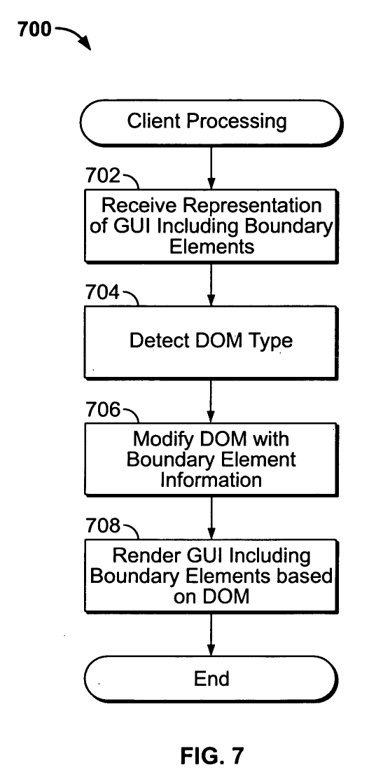

Referring to FIG. 7, a flow diagram showing a process 700 for rendering a GUI including boundary elements is shown. A representation of the GUI including at least one boundary element and services 308 is provided to the client (step 702). The type of web browser document object model is detected (step 704). The detected web browser DOM corresponds to a web browser executing on the client. For example, as described above in reference to FIG. 3, the representation of the GUI can include services 308. The services 308 can include functionality to detect the type of model 312 at the client 306. A portion of the services are executed to modify the DOM, i.e., model 312, to include information for representing the boundary elements on the GUI (step 706). The portion of the services selected to be executed is selected based on which model 312 was detected. In this way, the boundary elements can be rendered in any of a variety of web browsers, while maintaining a substantially identical appearance and using the same application logic 310. The GUI is then rendered such that the boundary elements appear within the web browser's display window (step 708).

In one implementation, the functionality to detect the type of model 312 is included in a scripting language, such as JavaScript. The JavaScript navigator object can be examined to detect the web browser executing on the client. The “appName” member of the navigator object contains the name of the browser (e.g., Microsoft Internet Explorer), and the “appVersion” member of the navigator object contains the version (e.g., 5.0). Once the model 312 is known, the DOM can be modified appropriately. Other scripting languages can be used. For example, VBScript language can be used, but may not have the same portability across various web browsers as JavaScript.

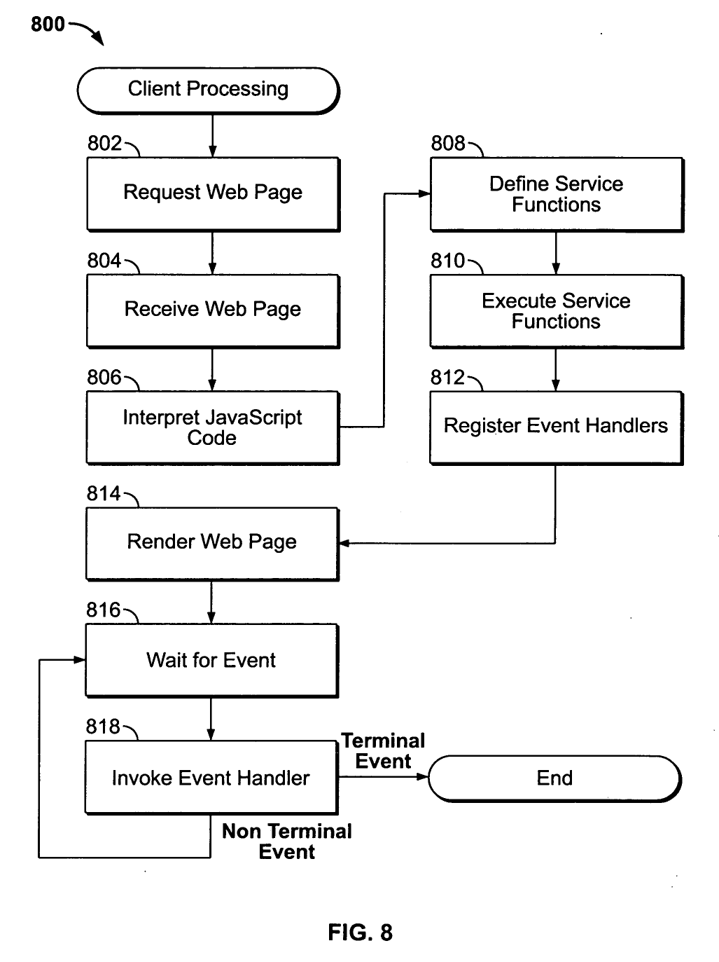

Referring to FIG. 8, a flow diagram showing a particular implementation of a process 700 for rendering a GUI including boundary elements is shown. For illustrative purposes, the process 800 shall be described with reference to the system 300 shown in FIG. 3, although it should be understood that a system having a different configuration can implement the process 800. The client 306 sends a request for a web page to a server 304 (step 802). The client 306 receives the web page from the server 304, where the web page includes DHTML and JavaScript (step 804). Embedded JavaScript code including the services 308 and the client-side application logic 310 is then interpreted by a web browser on the client 306 (step 806).

Interpreting the embedded JavaScript code includes examining the JavaScript navigator object to determine the name and version of the web browser executing in the client, and therefore determining the corresponding document object model 312. Interpreting the embedded JavaScript code further includes defining JavaScript service functions, i.e., the services 308 (step 808), executing the service functions to create boundary elements (step 810), and registering JavaScript event handlers for boundary elements (step 812). Different JavaScript code in the services 308 can be executed, depending on which model 312 has been detected. In this way, the boundary elements can be rendered in any of a variety of web browsers, while maintaining a substantially identical appearance and using the same application logic 310.

The web page, i.e., GUI 314, with boundary elements is then rendered and displayed to a user on display device 316 (step 814). In one embodiment, the client 306 can wait for any events generated by the user interacting with the GUI, input devices, and/or the client (step 816). The appropriate JavaScript handler is invoked, if any (step 818). If the event is non-terminal, that is the event does not require the client to cease waiting for events, the client continues waiting for subsequent events (step 816). Otherwise, client processing ends.

In one implementation, the above described systems and features are implemented in a web application including a GUI that includes one or more boundary elements for entry of time keeping information, for example, the Web TimeSheet and Web Time Off products available from Replicon Inc., of Calgary, Alberta, Canada. In one embodiment, the time tracking web application is configured to allow employees or other timekeepers to enter the time information (e.g., hours worked) on a web page for given activities. In one embodiment, time can be entered on a configurable time sheet. Timesheets can be configured to implement overtime rules. Additionally, the web application can allow a timekeeper or employer to determine how much time a timekeeper has accrued on different projects. Timekeepers can be organized into groups that can be customized by such definitions as location, level of seniority, department, project team, and/or skill set to reflect the way a company operates. In one embodiment, custom projects for tracking time can be created. Projects can be used to specify billable rates based on project, task, resource or employee role. Project costs can be allocated on a percentage basis and the same project can be assigned to two or more clients. In another embodiment, expense management is available to track project costs, taxes, reimbursement amounts, and other relevant expenses. Time entry and changes to times can be subject to one or more approvals which are managed by the web application. The web application can integrate electronic mail for sending timesheet reminders and can integrate with other project management applications. User input required for performing the functionality described can be received using boundary elements displayed on a GUI that are implemented as described above.

In one embodiment, the time entry web application can include a system for managing activities associated with entering, approving, and consolidating time off requests for employees. The web application can include functionality for automatically coordinating and gathering all time off requests, and a reporting and export system for consolidating the information for corporate needs. In aspects of this embodiment, an approval process in which decisions can be made easily based on knowledge of the employees' past and outstanding requests, as well as any potential conflicts with their fellow employees. A simple calendar-based method for entering time off requests, as well as a tool to monitor past requests, outstanding requests, or the status of their current time off entitlements can be provided. User input required for performing the functionality described can be received using boundary elements displayed on a GUI that are implemented as described above.

In another implementation, the above described systems and features are implemented in a web application including a GUI that includes one or more boundary elements for entry of resource management information, for example, the Web Resource product available from Replicon Inc., of Calgary, Alberta, Canada. In one embodiment, a resource management web application provides users the ability to create and share time schedules via a web page interface. The resource management application can provide different access levels are available for different user types. Users can define employee resources, associating them with availability, rates, skills, skill levels and other information that is customized for an organization and a staff. The resource management application allows users to view resource pools and associated schedules and can provide graphical calendar views to allow users to quickly view projects or resources and identify where staff are allocated, and over or under committed. Likewise, the resource management application can be used to identify any resources that are over-allocated and make the necessary adjustments. Resources can be assigned to projects, taking into account: available skills and resource requirements, the availability of resources due to commitments to other projects, planned time off periods, and placeholders for positions where specific personnel assignments need to be deferred. Project definitions can include tasks, dates, and attributes such as project type, approval/progress status, and billing class. Project and staffing settings can be adjusted for exploring alternative scenarios. The web application allows for customizable permissions and groups to restrict and filter presentation data to the applicable available data. User input required for performing the functionality described above can be received using boundary elements displayed on a GUI that are implemented as described above.

Referring again to FIG. 3, other embodiments are possible. While the storage 302, the server 304, the client 306, and the display device 316 are depicted as separate components, they are not limited to being embodied in separate devices. In one embodiment, two or more of the components can be embodied on the same computing device. For example, the storage 302 can be part of the server 304. In another embodiment, two or more of the components are connected by one or more computer networks. For example, the storage 302, the server 304, the client 306 and the display device 316 can each be distributed on a network.

The systems and techniques described here can be implemented in a computing system that includes a back end component (e.g., a data server), a middleware component (e.g., an application server), and a front end component (e.g., a client computer having a GUI or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), a personal area network (“PAN”), a mobile communication network, and/or the Internet.

The computing system can include clients and servers. A client and server are generally remote from each other and typically interact through a communication network. The relationship of client and server arises by virtue of computer programs running on the respective computers and having a client-server relationship to each other.

Various implementations of the systems and techniques described here can be realized in digital electronic circuitry, integrated circuitry, specially designed ASICs (application specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

A number of embodiment of the invention have been described. Nevertheless, it will be understood that various modifications may be made without departing from the spirit and scope of the invention. The logic flows depicted in FIGS. 7 and 8 do not require the particular order shown, or sequential order, to achieve desirous results, and the steps of the invention can be performed in a different order. Accordingly, other embodiments are within the scope of the following claims.

What is claimed is:

1. A computer-implemented method for providing a graphical user interface for a web application, comprising:
receiving in a web browser executing on a client a representation of the graphical user interface for the web application from a server, where the representation includes a description of at least one boundary element, the at least one boundary element including within a boundary established by the boundary element at least one of text, a graphic or a control element;
receiving in the web browser services, the services specified in a scripting language;
executing at least one of the services at the client to detect a web browser document object model from among a plurality of possible web browser document object models, where the detected web browser document object model corresponds to the web browser executing on the client;
selectively executing a portion of the services at the client to modify the detected document object model to include information pertaining to the at least one boundary element, where the portion is selected based on which document object model was detected;
rendering the graphical user interface in a web browser window, including, based on the modified document object model, rendering the at least one boundary element displayed within a boundary of the web browser window.

2. The method of claim 1, where the representation and the services are received in a same HTML document.

3. The method of claim 1, where the services are specified in JavaScript.

4. The method of claim 1 where modifying the detected document object model further comprises:
interpreting the services and instantiating at least one boundary element in the detected document object model.

5. The method of claim 1 further comprising:
requesting the representation of the graphical user interface from a server.

6. A computer program product, encoded on an information carrier, comprising instructions operable to cause data processing apparatus to:
receive in a web browser executing on a client a representation of a graphical user interface for a web application from a server, where the representation includes a description of at least one boundary element, the boundary element including within a boundary established by the boundary element at least one of text, a graphic or a control element;
receive in the web browser services, the services specified in a scripting language;
execute at least one of the services at the client to detect a web browser document object model from among a plurality of possible web browser document object models, where the detected web browser document object model corresponds to the web browser executing on the client;
selectively execute a portion of the services at the client to modify at the client the detected document object model to include information pertaining to the at least one boundary element, where the portion is selected based on which document object model was detected; and
render the graphical user interface in a web browser window, including, based on the modified document object model, rendering the at least one boundary element displayed within the boundary of the web browser window.

7. The computer program product of claim 6, where the representation and the services are included in a same HTML document.

8. The computer program product of claim 6, where the services are specified in JavaScript.

9. The computer program product of claim 6, further comprising instructions operable to cause the data processing apparatus to:
interpret the services and instantiating at least one boundary element in the detected document object model.

10. The computer program product of claim 6, further comprising instructions operable to cause the data processing apparatus to:
request the representation of the graphical user interface and the services from a server.

11. A computer-implemented method for providing a graphical user interface for a web application, comprising:
receiving in a web browser executing on a client a representation of the graphical user interface for the web application from a server, where the representation includes a description of at least one boundary element, the at least one boundary element including within a boundary established by the boundary element at least one of text, a graphic or a control element;
receiving in the web browser services, the services specified in a scripting language;
executing at least one of the services at the client to detect a web browser document object model from among a plurality of possible web browser document object models, where the detected web browser document object model corresponds to the web browser executing on the client;
selectively executing a portion of the services at the client to modify the detected document object model to include information pertaining to the at least one boundary element, where the portion is selected based on which document object model was detected;
rendering the graphical user interface in a web browser window, including, based on the modified document object model, rendering the at least one boundary element displayed within a boundary of the web browser window, the graphical user interface providing one or more fields for user input; and
receiving user input within the one or more fields, the user input comprising at least one of time keeping information or resource management information.

12. The method of claim 11, where the time keeping information includes an amount of time spent on a project.

13. The method of claim 11, where the time keeping information includes a billable rate based on at least one of the following: project, task or employee role.

14. The method of claim 11, where the time keeping information includes a time off request.

15. The method of claim 11 where the resource management information includes a time schedule.

16. A computer program product, encoded on an information carrier, comprising instructions operable to cause data processing apparatus to:
receive in a web browser executing on a client a representation of a graphical user interface for a web application from a server, where the representation includes a description of at least one boundary element, the boundary element including within a boundary established by the boundary element at least one of text, a graphic or a control element;
receive in the web browser services, the services specified in a scripting language;
execute at least one of the services at the client to detect a web browser document object model from among a plurality of possible web browser document object models, where the detected web browser document object model corresponds to the web browser executing on the client;
selectively execute a portion of the services at the client modify at the client the detected document object model to include information pertaining to the at least one boundary element, where the portion is selected based on which document object model was detected;
render the graphical user interface in a web browser window, including, based on the modified document object model, rendering the at least one boundary element displayed within the boundary of the web browser window, the graphical user interface providing one or more fields for user input; and
receive user input within the one or more fields, the user input comprising at least one of time keeping information or resource management information.

17. The computer program product of claim 16, where the time keeping information includes an amount of time spent on a project.

18. The computer program product of claim 16, where the time keeping information includes a billable rate based on at least one of the following: project, task or employee role.

19. The computer program product of claim 16, where the time keeping information includes a time off request.

20. The computer program product of claim 16, where the resource management information includes a time schedule.

21. A computer-implemented method for providing a modal dialog for a web application, comprising:
receiving in a web browser executing on a client a representation of a graphical user interface for the web application from a server, where the representation includes a description of a modal dialog boundary element, the modal dialog boundary element including within a boundary established by the modal dialog boundary element at least one control element;
receiving in the web browser services, the services specified by a scripting language;
executing at least one of the services at the client to detect a web browser document object model from among a plurality of possible web browser document object models, where the detected web browser document object model corresponds to the web browser executing on the client;
selectively executing a portion of the services at the client to modify the detected document object model to include information pertaining to the modal dialog boundary element; and
rendering the graphical user interface in a web browser window, including, based on the modified document object model, rendering the modal dialog boundary element within the boundary of the web browser window.

22. The method of claim 21, where modifying the detected document object model includes modifying a visual representation of the graphical user interface such that a user is prevented from avoiding interaction with the at least one control element included in the modal dialog boundary element.

23. The method of claim 22, where the modifying a visual representation comprises:
disabling elements in the graphical user interface other than the modal dialog boundary element.

24. The method of claim 22, where the modifying a visual representation comprises:
creating a transparent, translucent or opaque layer beneath the modal dialog boundary element.

25. The method of claim 21 where:
the representation and the services are received in a same HTML document.

26. The method of claim 21 where:
the services are specified in JavaScript.

27. The method of claim 21 where modifying the detected document object model further comprises:
instantiating the modal dialog boundary element in the detected document object model.

28. A computer program product, encoded on an information carrier, comprising instructions operable to cause data processing apparatus to:
receive in a web browser executing on a client a representation of a graphical user interface for a web application from a server, where the representation includes a description of a modal dialog boundary element, the modal dialog boundary element including within a boundary established by the modal dialog boundary element at least one control element;
receive in the web browser services, the services specified in a scripting language;
execute at least one of the services at the client to detect a web browser document object model from among a plurality of possible web browser document object models, where the detected web browser document object model corresponds to a web browser executing on the client;
selectively execute a portion of the services at the client to modify the detected document object model to include information pertaining to the modal dialog boundary element; and
render the graphical user interface in a web browser window, including, based on the modified document object model, rendering the modal dialog boundary element within the boundary of the web browser window.

29. The computer program product of claim 28, further comprising instructions operable to cause the data processing apparatus to:
modify a visual representation of the graphical user interface such that a user is prevented from avoiding interaction with the at least one control element included in the modal dialog boundary element.

30. The computer program product of claim 29, further comprising instructions operable to cause the data processing apparatus to:
disable elements in the graphical user interface other than the modal dialog boundary element.

31. The computer program product of claim 29, further comprising instructions operable to cause the data processing apparatus to:
create a transparent, translucent or opaque layer beneath the modal dialog boundary element.

32. The computer program product of claim 28 where the services are specified in JavaScript.

33. The computer program product of claim 28 where the representation and the services are received in a same HTML document.

34. A system for providing a graphical user interface for a web application, comprising:
a client executing a web browser, the client configured to:
receive a representation of the graphical user interface for the web application from a server, the representation comprising a description of at least one boundary element and a group of services specified in a scripting language where the group of services is configured to modify a detected web browser document model to include information pertaining to the at least one boundary element;
execute at least one service in the group of services to detect a web browser document object model from among a plurality of possible web browser document object models, where the detected web browser document object model corresponds to the web browser;
selectively execute at least one service in the group of services to modify the detected document object model to include information pertaining to the at least one boundary element, where the at least one service is selected based on which document object model was detected; and
render the graphical user interface in a web browser window, including, based on the modified document object model, rendering the at least one boundary element displayed within the boundary of the web browser window.

35. The system of claim 34, further comprising:
the server configured to send a representation of the graphical user interface for the web application to the client.

36. The system of claim 34, where:
the services are specified in JavaScript.

37. The system of claim 34, where the client is further configured to:
instantiate the at least one boundary element in the detected document object model.
